(19) United States
(12) Patent Application Publication
(10) Pub. No.: US 2018/0029320 A1
(43) Pub. Date: Feb. 1, 2018

(54) MANUFACTURING PROCESS OF A LEATHER EYEGLASS FRAME AND EYEGLASS FRAME OBTAINED WITH SUCH A PROCESS

(71) Applicants: Daniele MARCONETTI, Montegranaro (FM) (IT); Elia OLIVIERI, Montegranaro (FM) (IT)

(72) Inventors: Daniele MARCONETTI, Montegranaro (FM) (IT); Elia OLIVIERI, Montegranaro (FM) (IT)

(21) Appl. No.: 15/127,112

(22) PCT Filed: Mar. 18, 2015
(86) PCT No.: PCT/EP2015/055720

§ 371 Date: Sep. 19, 2016

(30) Foreign Application Priority Data
Mar. 21, 2014 (IT) MC014A000029

(51) Int. Cl. B29D 12/02; B68F 1/00; G02C 5/18; G02C 5/00

(52) U.S. Cl. CPC B29D 12/02; G02C 5/008; B68F 1/00; G02C 5/18; G02C 2200/12; G02C 2200/14

(57) ABSTRACT

A manufacturing process of a leather eyeglasses frame and eyeglasses frame obtained with such a process is disclosed. An eyeglasses frame is provided wherein the frontal lens-holder frame, and possibly each of the two lateral temples, are made of two identical layers of leather, between which a thin reinforcing metal core is concealingly inserted.

The present patent application for industrial invention relates to a manufacturing process of a leather eyeglasses frame, and to the eyeglasses frame obtained with such a process.

Although the companies operating in this field are continuously working to change the aesthetics of eyeglasses, the same innovation effort is not found in the materials used.

As it is known, the current models of eyeglasses frames are usually made of metal or plastic materials, being convinced that these are the most suitable materials to ensure the rapidity and inexpensiveness of the operations that are necessary to manufacture an eyeglasses frame.

WO2013/182894 discloses a spectacle frame obtained from cutting a multi-layer panel comprising a structural layer disposed in sandwich configuration between two coating layers. Consequently, after cutting, the borders of the structural layer, which is generally made of metal, remain visible, thus generating an unpleasant aesthetic effect on the eyeglasses frame. As a matter of fact, a person looking at the eyeglasses frame will understand that the eyeglasses frame comprises a metal structural support.

The specific purpose of the present invention is to boost the eyeglasses sector, which is still focused on traditional structural solutions.

Another purpose of the present invention is to provide an eyeglasses frame made of a natural, environmental-friendly material, which is certainly able to meet the requests of consumers with a high awareness of environmental issues.

These purposes are achieved according to the present invention with the characteristics claimed in the attached independent claims.

Advantageous embodiments appear from the dependent claims.

According to the present invention it has been devised to create leather eyeglasses frames or eyeglasses frames provided with a thin support metal core that is coated on both sides (and thus completely concealed) with two corresponding layers of leather.

In view of the above similar eyeglasses really give the impression of being completely made of leather, thus distinguishing themselves immediately and clearly at the eyes of a potential customer with respect to the ordinary eyeglasses with plastic or metal frames.

Another characteristic of the eyeglasses frame obtained with the process of the present invention is the sensation of softness given by the leather coating when the user touches the eyeglasses frame.

Such softness is the newest and the most distinctive element of a similar eyeglasses frame, especially when compared to traditional eyeglasses frames, which are all characterized by the use of very hard materials.

As a main option, the eyeglasses frame is coated with leather in all its parts, i.e. not only on the typical frontal lens-holding frame, but also on the two lateral temples.

The eyeglasses frame can also be obtained in a “hybrid version”, according to which the leather coating is provided only in the frontal lens-holding frame or only in the temples, and the part that is not coated with leather is traditionally made with plastic or metal.

Either one or both sides of a similar leather eyeglasses frame can be coated with a thin adhesive film decorated in such way to imitate leather, fabric, silk or other textile fibers.

Also in this case the eyeglasses frame is a strongly innovative object, in view of the softness of the (coated) leather experienced by the user when touching the frame.

The aforementioned purposes have been achieved with a special manufacturing process that consists in the ordered sequence of several operating steps.

One the most important aspects of the manufacturing process refers to the fact that it allows for obtaining two substantially annular grooves in the frontal lens-holding frame, which are intended to receive and firmly hold the perimeter borders of each lens without requiring the cooperation of external fixing means.

A similar solution is particularly appreciated, especially when the owner of a similar pair of eyeglasses with leather frame decides to replace either one or both lenses after breaking them or to simply change their color.

For explanatory reasons the description of the invention continues with reference to the attached drawings, which only have an illustrative, not limiting value, wherein:

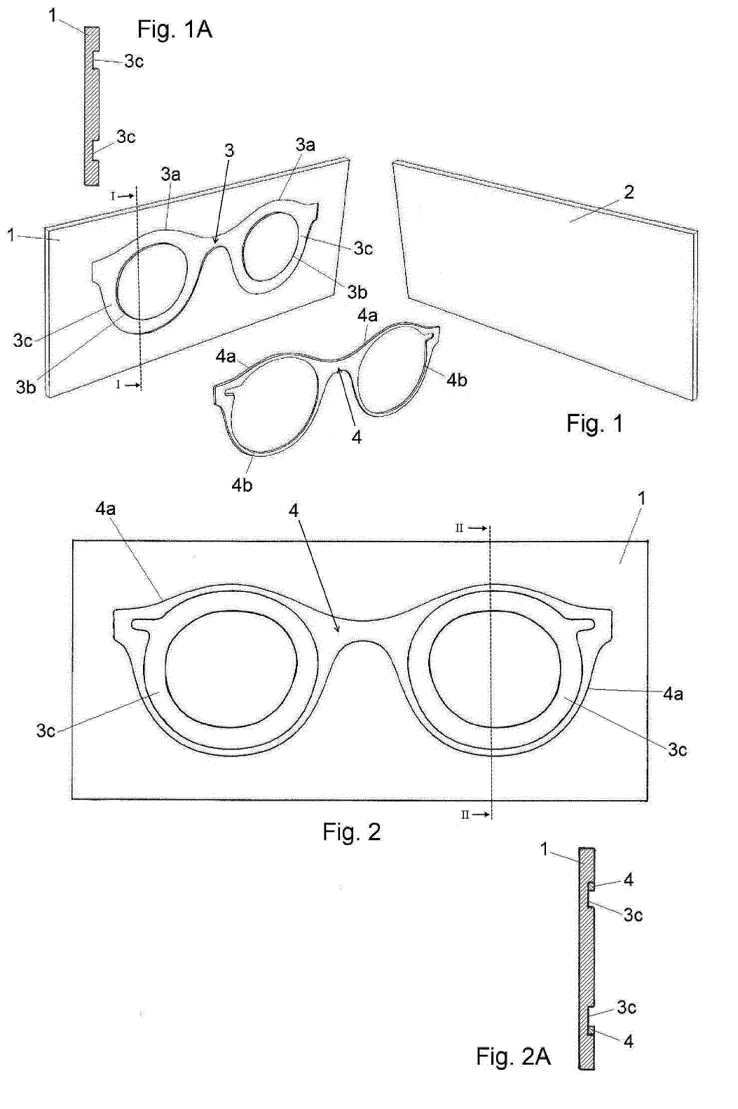

FIG. 1 is a perspective exploded view of the three parts used to obtain the frontal lens-holding frame of the leather eyeglasses frame of the invention;

FIG. 1A is a sectional view of FIG. 1 with plane I-I;

FIG. 2 is a front view of two of the three parts after coupling;

FIG. 2A is a sectional view of FIG. 2 with the plane II-II;

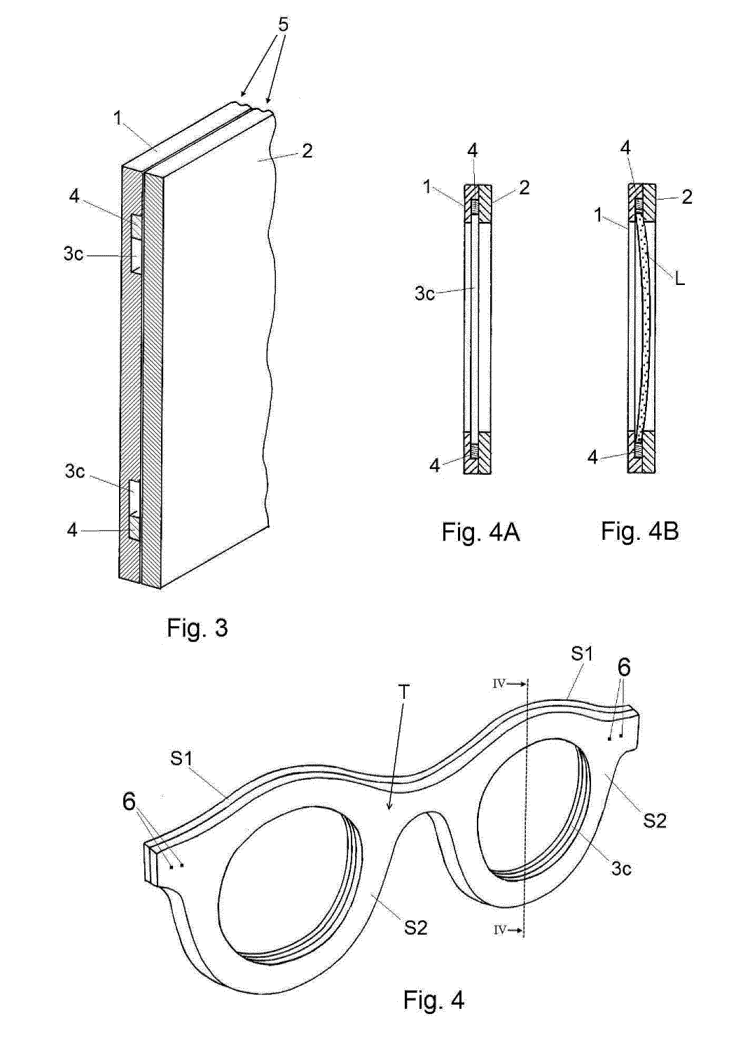

FIG. 3 shows a section of the semi-finished product obtained by coupling the three parts of FIG. 1, cut with a vertical plane that corresponds to the plane II-II of FIG. 2;

FIG. 4 is a perspective view of the frontal lens-holder frame of the leather eyeglasses frame;

FIG. 4A is a sectional view of FIG. 4 with the plane IV-IV;

FIG. 4B is the same as FIG. 4A, except for it shows a lens already inserted in the hole of the frontal lens-holding frame;

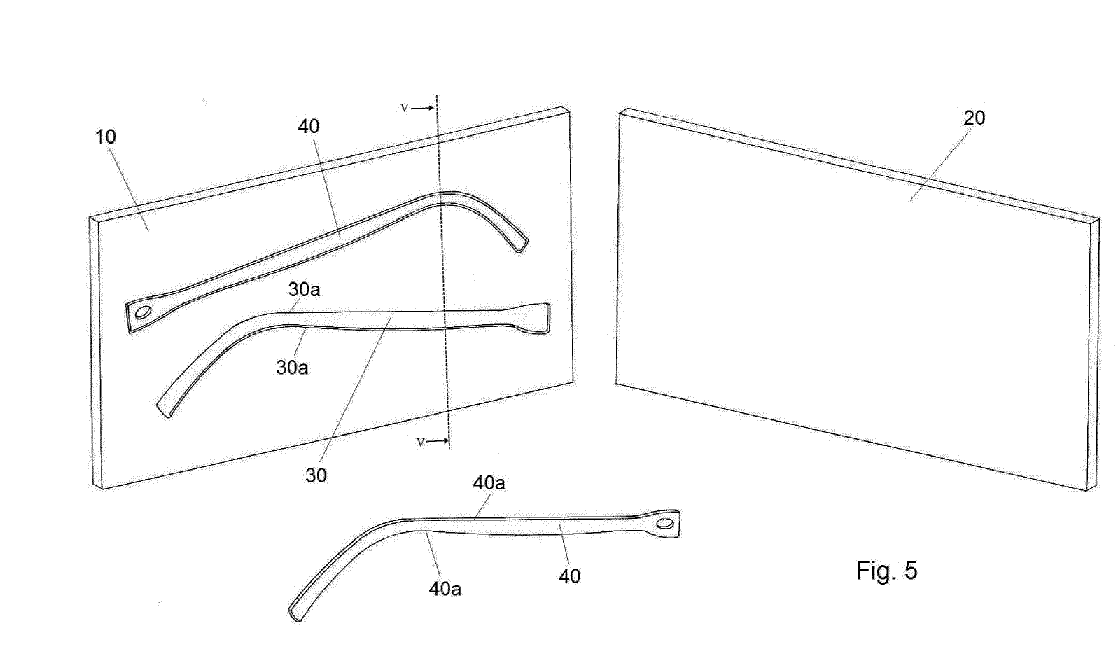

FIG. 5 is an exploded view of the parts used to make the two temples of the leather eyeglasses frame;

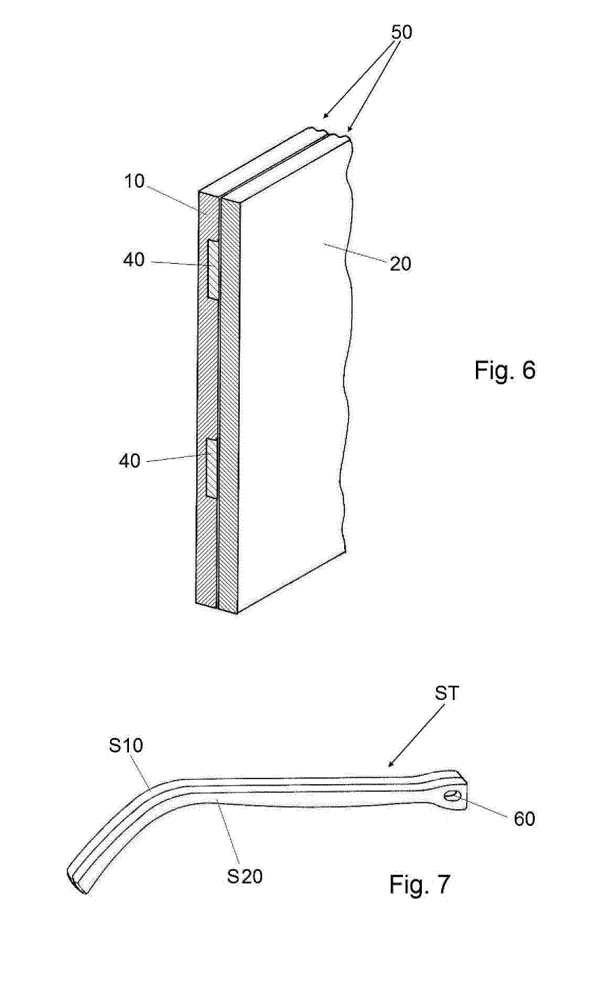

FIG. 6 shows a section of the semi-finished product obtained by coupling the parts of FIG. 5, cut with a vertical plane that corresponds to the plane V-V of FIG. 5;

FIG. 7 shows one of the temples of the leather eyeglasses frame.

With reference to FIGS. 1 to 4B, the process of the invention is implemented to obtain a frontal lens-holding frame (T) of an eyeglasses frame.

Such a process comprises the following operating steps:

a) cutting of a first leather portion and a second leather portion (1, 2) with substantially rectangular shape from a leather panel, the said portions comprising a flesh side and a grain side; the said cutting operation being preferably made with water cutting technology;

b) realization of an impression (3) on the flesh side of the first leather portion (1), which exactly corresponds to the profile of the lens-holding frame (T) to be obtained; the said impression (3) being obtained by carving the first leather portion (1) preferably with laser technology, as shown in FIG. 1; in such manner a recessed impression (3) is obtained.

c) insertion of a thin metal core (4) in the impression (3), which reproduces the profile of the lens-holding frame (T) to be obtained; the said metal core (4) being intended to be the bearing and reinforcing element of the lens-holding frame (T); wherein the external contours (4a) of the metal core (4) exactly correspond to the external contours (3a) of the impression (3); the internal contours (4b) of the metal core (4) surrounding holes suitable for mounting the lenses; the internal contours (4b) of the metal core (4) being in backward position with respect to the internal contours (3b) of the impression (3), thus forming a pair of substantially annular grooves (3c) in the impression (3), which are not occupied by the metal core (4), as shown in FIG. 2A;

d1) application of a layer of glue on the flesh side of both leather portions (1, 2);

e) when the glue is dry, coupling of the two leather portions (1, 2) and pressing of the two leather portions (1, 2) to consolidate a mutual adhesion of the flesh sides and favor the formation of a semi-finished product (5) provided with a substantially sandwich structure formed of the two leather portions (1, 2) and the metal core (4) disposed between them, as shown in FIG. 3;

f) water cutting of the semi-finished product (5) perfectly following both the external contours (3a) and the internal contours (3b) of the impression (3) that contains the metal core (4) by means of suitable references set between the semi-finished product (5) and the water cutting machine.

The lens-holding frame (T) is obtained at the end of this operation, it being formed of two identical layers of leather (S1, S2), between which the metal core (4) with bearing and reinforcing function is concealingly inserted, as shown in FIG. 4. The provision of the recessed impression (3) that receives the metal core (4) makes the metal core (4) invisible after coupling the two layers of leather (S1, S2).

With reference to FIGS. 4A and 4B, because of the device provided in step c), the lens-holding frame (T) is characterized in that it is provided with the two annular grooves (3c) all around the holes for the lenses. The said annular grooves (3c) are comprised between the two layers of leather (S1, S2) of the lens-holding frame (T).

The annular grooves (3c) are extremely advantageous in order to surround and exactly hold the perimeter borders of the lenses (L) that are to be mounted on the lens-holding frame (T).

The method according to the invention also provides for the following additional operating steps:

g) provision of holes (6) at the ends of the lens-holding frame (T) in order to mount the hinges for the temples (S) provided together with the lens-holding frame (T); the said operation is carried out together with the aforementioned step f) using the same machine tool suitable for making the water cut operation that is used to generate the formation of the lens-holding frame (T);

h) trimming of the internal contours and the external contours of the lens-holding frame (T);

i) press folding of the said lens-holding frame (T) in order to impose the internal metal core (4) of the lens-holding frame (T) a curvature that is normally provided in this specific part of every and each eyeglasses frame;

l) surface finishing of both leather layers (S1, S2) of the lens-holding frame (T); the said finishing being made by applying one or more layers of transparent or colored paint and/or by applying an adhesive transparent or decorated film.

The aforementioned operations must be carried out also to obtain the two leather temples (ST) intended to be associated with the lens-holding frame (T).

With reference to FIGS. 5, 6 and 7, in such a case a second semi-finished product (50) analogous to the first semi-finished product is to be obtained. The second semi-finished product (50) has a sandwich structure and is formed of a third leather portion and a fourth leather portion (10, 20) with rectangular shape, which are firmly interfaced, and of two metal cores (40), one of each temple (ST); each metal core (40) is to be exactly inserted inside a corresponding impression (30) obtained on the internal side of the third leather portion (10). The impression (30) is recessed with respect to the third leather portion (10).

In this second case, the metal core (40) of each temple (ST) is intended to exactly and entirely fill the respective impression (30) obtained on the third leather portion (10), unlike the case of the lens-holding frame (T), wherein the metal core (4) must leave free, inside the impression (3), the two annular spaces that favor the formation of the annular grooves (3c) intended to exactly receive the perimeter edges of the lenses.

In order to manufacture the temples (ST), the external contours (40a) of the metal cores (40) are intended to exactly coincide with the external contours (30a) of the impressions (30).

Therefore, the aforementioned step f)—which provides for executing the water cut on the second semi-finished product (50)—is limited to exactly following the external contours (30a) of the impression (30) that receives the metal core (40) of each temple (ST).

Such a step f) can be preferably used also to make, in the internal end of each temple (ST), the holes (60) intended to fix the hinges suitable for joining the temple (ST) at one end of the lens-holding frame (T); the execution of the holes can be also carried out in a successive and specific operating step.

In any case, at the end of a similar process, each of the temples is made of two layers of leather (S10, S20), among which the metal core (40) is concealingly inserted, as shown in FIG. 7. Because of the provision of the recessed impression (30) that contains the metal core (40), the metal core (40) is not visible when the two layers of leather (S10, S20) are coupled.

For the final manufacturing of the eyeglasses frame, the lens-holding frame (T) and the two temples (ST) are assembled by installing traditional hinges mounted between the holes (6) provided on each of the ends of the lens-holding frame (T) and the holes (60) provided at the end of each temple (ST).

In spite of being made of leather, the lens-holding frame (T) can be coupled with a pair of traditional temples, i.e. temples that are not provided with a leather structure (which are normally made of metal or plastic material).

1. Manufacturing process of a leather eyeglasses frame, comprising the following steps:
a1) preparation of a first leather portion and a second leather portion with substantially rectangular shape, provided with a flesh side and a grain side;
b1) realization of a impression corresponding to the profile of a lens-holding frame of an eyeglasses frame on the flesh side of the first portion of leather, wherein the said impression has external contours and internal contours;
c1) insertion of a metal core reproducing the profile of the lens-holding frame in the impression; wherein the said metal core has external contours and internal contours that surround holes suitable for mounting the lenses; the external contours of the metal core exactly corresponding to the external contours of the impression, and the internal contours of the metal core being in backward position compared to the internal contours of the impression, in such manner to generate the formation of two substantially annular grooves in the impression, which are not occupied by the metal core;
d1) application of a layer of glue on the flesh side of the said first and second leather portion;
e1) interfacing and pressing of the first and second leather portion in order to consolidate the mutual adhesion of the flesh sides, in such manner to obtain a first semi-finished product with a basically sandwich structure, being formed of the said first and second leather portion and of the said metal core disposed between them;
f1) cutting of the said first semi-finished product exactly on the external contours and the internal contours of the said impression that houses the metal core.

2. The process of claim 1, also comprising the following steps:
a1) preparation of a third and a fourth leather portion with substantially rectangular shape, provided with a flesh side and a grain side;
b1) realization of a pair of impressions corresponding to the profiles of two temples of an eyeglasses frame on the flesh side of the third leather portion, each impression having external contours and internal contours;
c2) insertion of two metal cores reproducing the profile of the temples in the two impressions; wherein each metal core has external contours and internal contours; the external contours of each metal core exactly corresponding to the external contours of the respective impression;
d1) application of a layer of glue on the flesh side of the said third and fourth leather portion;
e1) interfacing and pressing of the third and fourth leather portion in order to consolidate the mutual adhesion of the flesh sides, in such manner to obtain a second semi-finished product with a basically sandwich structure, being formed of the said third and fourth leather portion and of the said metal core disposed between them;
f2) cutting of the said second semi-finished product exactly on the external contours of the two impressions that contain the metal cores.

3. The process of claim 2, comprising the additional step of assembling the said lens holding frame and the said temples.

4. The process of claim 1, comprising the following additional step:
g1) preparation of holes for mounting hinges for connection with the temples at the ends of the said lens holding frame, wherein the said holes are obtained during or after the operating step.

5. The process of claim 2, comprising the following additional step:
g2) preparation of holes for mounting hinges for connection with the lens holding frame at the end of each temple, wherein the said holes are obtained during or after the operating step.

6. The process of claim 1, comprising the following additional step:
h1) trimming of the internal and external contours of the said lens holding frame.

7. The process of claim 1, comprising the following additional step:
h2) trimming of the contours of each of the said temples.

8. The process of claim 1, wherein the following additional operating step is comprised:
i) press-folding of the said lens-holding frame in such manner to impose the desired curvature on the lens-holding frame.

9. The process of claim 1, wherein the following additional operating steps are comprised:
l) surface finishing of the said lens-holding frame and/or the said temples.

10. Leather eyeglasses frame comprising a lens-holding frame and two temples connected to the lens-holding frame, wherein the said lens-holding frame is formed of two layers of leather that are mutually coupled, with the interposition of a metal core (4),
characterized in that
one layer of leather of the said two layers of leather of the lens-holding frame comprises a recessed impression that contains the metal core, in such manner that the metal core is not visible when the two layers of leather are coupled.

11. The leather eyeglasses frame of claim 10, wherein each temple is formed of two layers of leather that are coupled with the interposition of a metal core and wherein one layer of leather of the two layers of leather of the temple comprises a recessed impression that contains the metal core, in such manner that the metal core is not visible when the two layers of leather are coupled.
